(19) United States
(12) Patent Application Publication
(10) Pub. No.: US 2011/0295734 A1
(43) Pub. Date: Dec. 1, 2011

(54) System and Method for Implementing and Managing Basis Futures

(76) Inventors: Richard Co, Chicago, IL (US); Brett Vietmeier, DeKalb, IL (US); John Labuszewski, Westmont, IL (US)

(21) Appl. No.: 12/827,426

(22) Filed: Jun. 30, 2010

Related U.S. Application Data
(60) Provisional application No. 61/348,423, filed on May 26, 2010.

(51) Int. Cl. G06Q 40/00

(52) U.S. Cl. 705/37

(57) ABSTRACT

A method for implementing a basis futures contract is disclosed. The method includes receiving trade data at a server, defining, at the server, a first futures contract based on an index identified in the received trade data, defining, at the server, a second futures contract based on a basis associated with the index identified in the received trade data, such that the basis reflects a fair value associated with the first futures contract, listing, via a match module, at least the second futures contract, matching, via the match module, at least the second futures contract, and calculating, at the server, a final settlement price associated with the first contract based on a daily settlement price of the index and a basis future settlement price associated with the second contract.

### PRIORITY CLAIMS

This application claims the priority benefit provided under 35 U.S.C. §119(e) to U.S. Prov. Pat. App. No. 61/348,423, (Atty. Dkt. 04672-00821) titled “SYSTEM AND METHOD FOR IMPLEMENTING AND MANAGING BASIS FUTURES,” filed on May 26, 2010. The content of this provisional patent application is incorporated herein by reference for all purposes.

### TECHNICAL FIELD

This patent document relates to a system and method for managing trading of investment vehicles, and more particularly, to a system and method for implementing and managing basis futures reflective of a perceived fair value.

### BACKGROUND

Basis or basis of futures is defined as the difference between the spot or cash price of a financial instrument or index, and a futures price of a contract for the same financial instrument or index.

Basis=Index Future Price−Spot Index Value

Basis is intended to reflect or correlate with the perceived “fair value” of a financial instrument or index and as such, it is often closely followed or tracked by many traders, institutional investors and/or other financial professionals. For example, an institutional investor may utilize the basis associated with, for example, an index by separately trading an index futures and an underlying stock portfolio represented by the index. Because the basis is expected and intended to represent the “fair value” of a futures contract, traders, institutional investors and/or other financial professionals track basis numbers as a matter of course in order to executes trades at what they perceive to be fair value for a variety of purposes.

Basis or basis of futures for a stock index futures contract is driven by arbitrage activity. For example, traders and institutional investors attempt to profit from temporary pricing misalignment between the futures and the spot index, or even the pricing misalignment between two different futures contracts. An arbitrageur may buy the stock portfolio underlying or represented by the stock index and simultaneously sell short an equivalent amount of futures based on the same index, should the basis become misaligned with the true financing cost of the stock portfolio, locking in a profit when the two positions converges later, perhaps at the expiration of the futures contract. If a stock index futures contract becomes under-priced (“cheap”) to spot equities, an arbitrageur might “buy the basis” by buying index futures and selling the underlying stock portfolio represented by the index. Conversely, if a stock index futures contract becomes over-priced (“rich”) relative to spot equities, one might “sell the basis” by selling futures and buying the underlying stock portfolio represented by the index. In this way, arbitrageurs make markets trade more efficiently by taking advantage of and causing corrections in momentary disparities that arise in prices between markets.

Buy The Basis→Buy Future/Sell Spot

Sell The Basis→Sell Future/Buy Spot

Arbitrage serves to reestablish or otherwise ensure equilibrium pricing relationships between markets is maintained or otherwise achieved. The profit or return on an arbitrage transaction depends, at least in part, on the costs of buying and holding stocks on a leveraged basis. These costs, in turn, are measured or otherwise defined in terms of finance charges offset any received dividend income.

Index Futures Price=Spot Index Value+Finance Charges−Dividends

Stock index futures prices are normally expected to increase to successively higher levels in successively deferred or future months. This is due to the fact that short-term interest rates typically exceed stock dividend yields. This is known as “negative carry” because it costs more to buy and hold stocks in terms of financing cost than stocks yield in dividends. In other words, the cost of money borrowed to finance securities or financial futures positions is higher than the dividend yield on those positions. Alternatively, rates may dip below dividend yields and stock index futures price at successively lower levels in successively deferred months. This is known as “positive carry” (i.e., where the cost of money borrowed to finance securities is lower than the yield on the securities). Under conditions of positive carry, futures prices tend to be less than spot values and the basis is quoted as a negative number.

This relationship presumes that cash or funds utilized to purchase or finance the stocks are borrowed at prevailing short-term interest rates. Thus, fair value represented by the basis is a function of the difference between finance charges and dividends. Accordingly, the basis may “flutter” or fluctuate up and down within a band or region before an arbitrageur recognizes a potential arbitrage opportunity. The breadth or width of the band is a function of the costs associated with the transaction. Exemplary costs may include brokerage fees, slippage, and profit margin. Thus, fair value represents where a futures contract theoretically should trade, but not necessarily where they will trade.

Trade-at-Settlement (TAS) and Trade-at-Index-Close (TIC) are previous methods of trading futures contracts aimed at providing and/or ensuring fair value pricing. TAS trades allow parties to enter into futures contracts where the price is set based on the settlement price at the end of the same trading day, regardless of the price of the futures contract at the time when the agreement was reached during the trading period. TIC trades allow parties to enter a bid or offer for a certain index futures contract during the course of the trading day at a price expressed as a differential to the closing price of the underlying stock index of the day. TIC trades are an alternative to TAS trades, in the situation in which there is a widely publicized closing price of an index at the close of business each day that is not subject to dispute. Spot closing prices are not available for all commodities and therefore TAS and/or TIC are not applicable to futures based on such commodities.

Traders desire a mechanism to more easily enter and exit positions in futures contracts at a value that reflects their perception of fair value for any particular day. Increases in trading efficiencies, pricing, execution, delivery and settlement of index futures contracts as well as the underlying stock index may increase liquidity and provide security for traders. Therefore, there is a need for systems and methods for quoting, administering, settling, and clearing of traded stock index futures.

### SUMMARY

A method for implementing a basis futures contract is disclosed. The method includes receiving trade data at a server, defining, at the server, a first futures contract based on an index identified in the received trade data, defining, at the server, a second futures contract based on a basis associated with the index identified in the received trade data, such that the basis reflects a fair value associated with the first futures contract, listing, via a match module, at least the second futures contract, matching, via the match module, at least the second futures contract, and calculating, at the server, a final settlement price associated with the first contract based on a daily settlement price of the index and a basis future settlement price associated with the second contract.

A computer implemented system for managing a basis future contract. The system includes a server configured to receive trade data from a trading party, generate a first futures contract based on an index identified in the received trade data, and define a second futures contract based on a basis associated with the index identified in the received trade data, wherein the basis reflects a fair value associated with the first futures contract. The system further includes a match module configured to list at least the second futures contract with a clearing counterparty, and wherein the match module if further configured to match at least the second futures contract, and wherein the server is further configured to calculate a final settlement price associated with the first contract based on a daily settlement price of the index and a basis future settlement price associated with the second contract.

A method of providing a basis future contract associated with a stock index futures contract. The method includes identifying, via trade data provided to a match client, a stock index, defining a basis future contact. Defining the contract further comprises determining a basis associated with the basis index future contract as a difference between an index future price and a spot index value, and determining a fair value associated with the basis index future contract as a difference between a finance charge and a dividend. The method further comprises listing the basis future contract with a clearing counterparty, and calculating, if the basis future contract is matched by a match module, a final settlement price associated with the stock index future based on a daily settlement price of the index and a basis future settlement price associated with the basis future contract.

The foregoing summary is provided only by way of introduction. The features and advantages of the basis futures and systems for quoting, administering, communicating, managing, placing, entering, receiving, matching, clearing, settling, presenting, listing and/or confirming orders for basis futures may be realized and obtained by the instrumentalities and combinations pointed out in the claims. Nothing in this section should be taken as a limitation on the claims, which define the scope of the invention. Additional features and advantages will be set forth in the description that follows, and in part will be obvious from the description, or may be learned by practice of the present invention.

Other embodiments are disclosed, and each of the embodiments can be used alone or together in combination. Additional features and advantages of the disclosed embodiments are described in, and will be apparent from, the following Detailed Description and the figures.

### BRIEF DESCRIPTION OF THE FIGURES

Examples of the invention are described with reference to the accompanying drawings, in which components, features and integral parts that correspond to one another each have the same reference number, wherein:

FIG. 1 illustrates an exemplary system for implementing a basis future in accordance with the disclosure presented herein;

FIG. 2 illustrates an exemplary match system which may be implemented in connection with the system shown in FIG. 1;

FIG. 3 illustrates an exemplary ordering method for basis futures which may be implemented in connection with the system shown in FIG. 1; and

FIG. 4 illustrates an exemplary method for clearing and settling open positions for basis futures.

### DETAILED DESCRIPTION

A system, apparatus, and/or method for quoting, administering, settling, and clearing basis futures provides a centrally cleared, guaranteed, and settled market for exchange listed basis futures is disclosed herein. In an aspect of the invention, mark-to-market gains may be monetized for the basis futures. Embodiments may be achieved by, among others, one or more devices, systems, networks, and/or processes for quoting, administering, communicating, managing, placing, entering, receiving, matching, clearing, settling, listing and/or confirming orders for basis futures.

In an exemplary embodiment, a system may include one or more trading terminal or devices in communication with an electronic exchange for a financial instrument. A trader may utilize the one or more trading terminals to create or define an order for a basis futures contract to submit to the exchange. The electronic exchange may include or utilize a match engine module, an order processing module, a mark-to-market module, a conversion module, a storage device, and other components for receiving, processing, and managing the order for the basis futures.

The system, apparatus, and/or method provide a mechanism by which traders, investors and other market participants may define and enter orders at levels that they perceive to be reflective of fair value. To this end, a derivatives contract, and a system and method for implementing the same, is provided that is quoted as the basis (or difference between spot and futures prices) but which calls for delivery of the underlying derivative at a value priced at the spot index value adjusted by the basis.

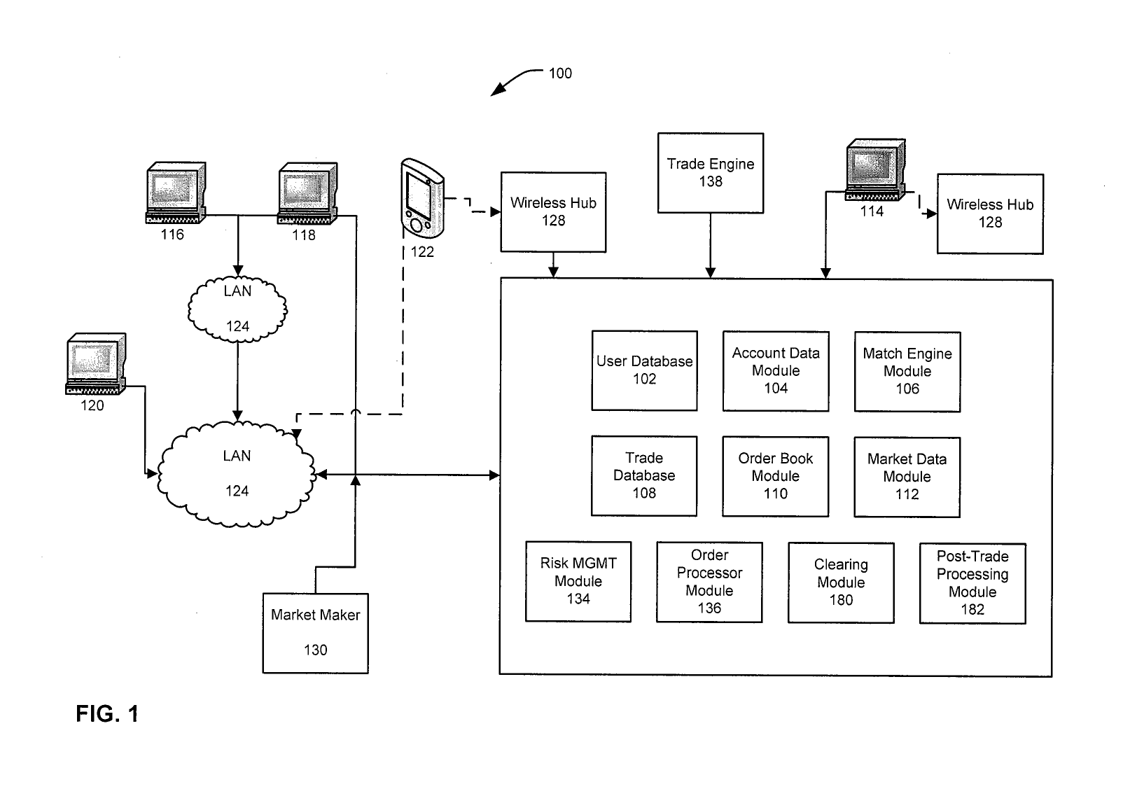

FIG. 1 illustrates an exemplary exchange computer system 100 or trading network configured to allow users to exchange trading information. The exemplary exchange computer system or trading network 100 may be configured to receive orders and transmit market data related to orders, trades and related information. Exchange computer system 100 may be implemented with one or more mainframes, servers, gateways, controllers, desktops or other computers.

The exchange computer system or trading network 100 may include a user database 102 configured to store and index information identifying traders, investors and other users of the system. The user database 102 may further store and index user names, passwords associated with user accounts stored in an account data module 104. The account data module 104 may process account information utilized during trades, clearing and/or margining operations.

The exchange computer system or trading network 100 may further include a match engine module 106, a trade database 108, an order book module 110, and a market data module 112. Match engine module 106 may be configured to match bid and offer prices. Match engine module 106 may be implemented with software that executes one or more algorithms for matching bids and offers. Trade database 108 may store information identifying trades and descriptions of trades. In particular, trade database 108 may store information identifying or associated with the time that a trade took place and the contract price. The order book module 110 may configured to compute or otherwise determine current bid and offer prices. A market data module 112 may be included to collect market data and prepare the data for transmission to users. A risk management module 114 may be included to compute and determine a user's risk utilization in relation to the user's defined risk thresholds.

The exchange computer system or trading network 100 may further include an order processing module 136, a clearing module 180 and/or a post-trading module 182. The order processing module 136 may be configured to decompose delta-based and bulk order types for processing by order book module 110 and match engine module 106. The clearing module 180 may be configured to clear outstanding long and short positions for basis futures on contract settlement day or any other trading day. The post-trade processing module 182 may further be configured to generate reports and enumerate details of the forward basis futures trade which may fulfill delivery obligations.

FIG. 1 further illustrates computers, terminal and other devices 114, 116, 118, 120 and 122. The computers, terminal and other devices 114, 116, 118, 120 and 122 may include one or more central processors, or controllers, coupled to one or more system buses that connect the central processor to one or more communication components, such as a network card or modem. The computers, terminal and other devices 114, 116, 118, 120 and 122 may further include interface units, drives, memory and storage modules for reading, writing storing data and computer executable instructions. Depending on the type of computer device, a user can interact with the computer with a keyboard, pointing device, microphone, pen device or other input device.

Computer device 114, in this exemplary embodiment, is in communication with the exchange computer system 100 via, for example, a T1 line, a wide area network (WAN), a local area network (LAN), a wireless local area network (WLAN) compliant with IEEE 802.11x or other communication standards capable of communicating or transporting the financial information utilized by the exchange computer system or trading network 100. Computer device 114 may further be in communication with a trader or exchange employee via a radio 132. The radio user may transmit orders or other information to a user of computer device 114 which, in turn, may then transmit the trade or other information to exchange computer system 100. As shown in FIG. 1, wireless communications and/or wireless communication channels are illustrated as dashed lines coupling two or more illustrated elements.

Computer devices 116 and 118 communicatively couple to the exchange computer system 100 via a local area network (LAN) 124. LAN 124 may have one or more of the known LAN topologies and may use a variety of different protocols, such as Ethernet, IEEE 802.11 (WiFi), IEEE 802.16 (WiMAX). Wireless personal digital assistant device (PDA) 122 may communicate with LAN 124 or the Internet 126 via, for example, WiFi and/or WiMAX communication protocols. PDA 122 may further communicate with exchange computer system 100 via wireless hub 128. PDA is defined broadly to include mobile telephones such as smart phones and other wireless devices, netbooks, tablet computers or other devices capable of communicating with the LAN 124 or wireless hub 128.

FIG. 1 further illustrates LAN 124 coupled to the Internet 126. Communication within the LAN 124 and between the Internet 126 may be facilitated by routers, domain name servers, gateways, virtual private network (VPN) servers, storage devices and other known networking equipment.

One or more market makers 130 may maintain a market by providing substantially constant bid and offer prices for a financial instrument, such as a derivative or security, to exchange computer system 100.

Exchange computer system 100 may also exchange information with other exchanges, markets represented by trade engine 138. Additional computers and systems such as, for example, clearing, regulatory and fee systems, may be coupled to exchange computer system 100 in the manner described above.

The operations of computer devices and systems shown in FIG. 1 may be controlled or directed by computer-executable instructions stored on computer-readable medium and executed by one or more processors. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Additional servers, computers, handheld devices, personal digital assistants, telephones and other devices may also be connected to exchange computer system 100. Moreover, the topology shown in FIG. 1 is merely an example and that the components shown and described in connection with the exemplary topography may be reconfigured and rearranged into different topologies and configurations.

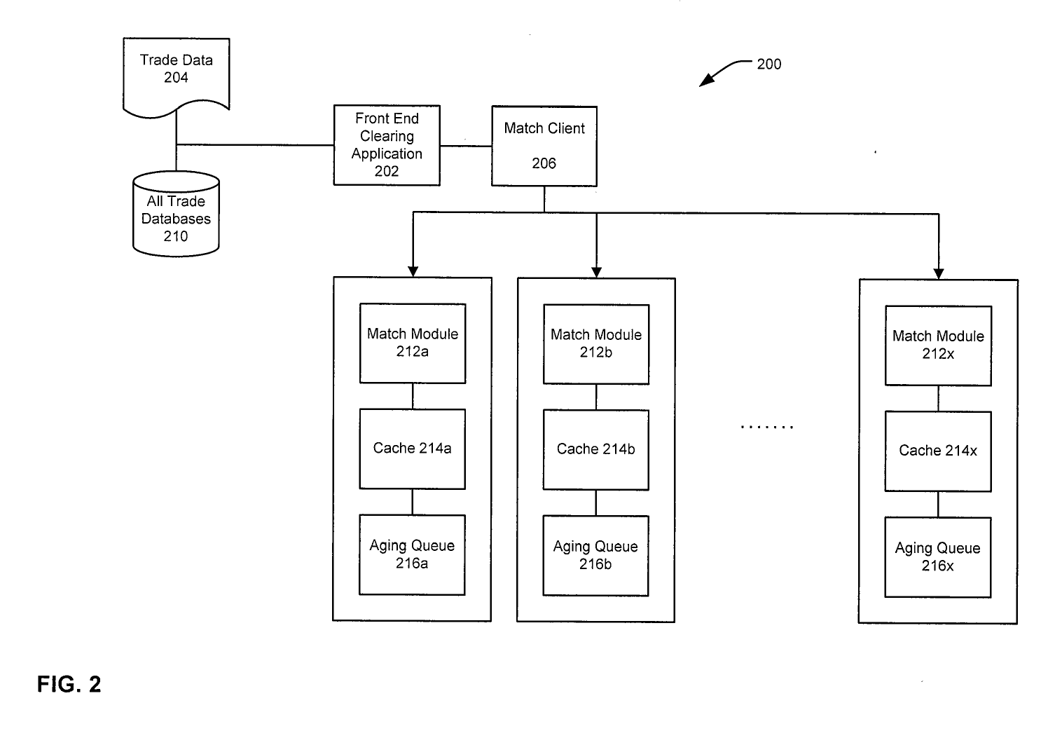

FIG. 2 illustrates an exemplary match system 200 that may be implemented to list, record, track and match orders and/or trades for basis futures and the stock indexes to which they relate. The match system 200 includes a front end clearing application 202 configured to receive trade data 204. Trade data 204 may include information that identifies an order for a futures contract such as the basis futures contract discussed and disclosed herein. For example, the match system 200 may utilize trade data 204 representative of, for example, an E-mini S&P 500 Stock Index futures contract which are listed on each trading day of the year by the Chicago Mercantile Exchange (CME or CMEGroup, Inc.) Chicago, Ill. Each contract is available from 8:30 am to 3:15 pm (CT) and may be traded on an electronic trading system such as the Globex® electronic trading system.

The match system 200, in this exemplary embodiment, operates as a central counterparty to each party of the contract. The central counterparty clears and ensures each trade handed by the match system 200. The action of the central counterparty provides and/or ensures capital efficiencies and minimizes risk for traders of the exchange traded derivative contacts.

In an exemplary embodiment, the match system 200 may be operating as a central counterparty for a market in E-mini S&P 500 Basis Futures offered by the CME. E-mini S&P 500 Basis Futures are quoted in terms of the basis in minimum increments or “ticks” of 0.05 index points with respect to E-mini S&P futures contracts. For the present example, this equates to $2.50 per tick and the basis may be quoted at +3.50 index points; or, at −4.75 index points.

A match client 206 may contain application program interfaces and/or other software modules that allow front end clearing application 202 to communicate with a plurality of match servers 208a and 208b. A variety of different match clients may be used to allow different front end clearing applications to communicate with match servers. For example, a first front end clearing application may use a first match client to communicate with a set of match servers and a second front end clearing application may use a second match client to communicate with the same set of match servers. Front end clearing application 202 is also coupled to an all trades database 210. All trades database 210 contains a master record of all trades that have taken place.

FIG. 2 further illustrates a pair of match servers 208a and 208b. Each of the match servers 208a and 208b may be in the same location or may be geographically distributed. As previously discussed, a pair of servers 208a and 208b are shown in this exemplary embodiment, but this configuration may be scalable to include both fewer and multiple additional services. Match servers 208a and 208b may each be connected to one another, connected through a common hub or connected in another manner that allows each match server to communicate with the remaining match servers. Servers 208a and 208b contain modules for matching orders, such as futures orders executed at an exchange. Server 208a includes a match module 212a that may be implemented with a software application that matches unmatched trades. Match module 212a may include or be linked to a set of rules for matching orders. The rules for matching orders may identify specific match criteria used for matching specific orders. As described in detail below, a match module may use several different match criteria and the match criteria selected may be a function of the length of time that order data has remained unmatched.

Server 208b, in one exemplary embodiment, may include match modules 212b that may be similar to match module 212a. The match modules 212a and 212b may be used to match specific types of orders or trades that take place in specific locations. For example, match module 212a may be configured to match orders that were executed at one exchange and match module 212b may be used to match orders that were executed at another exchange.

Servers 208a and 208b may receive and store trade data from front end clearing application 202 in caches 214a and 214b, respectively. In one embodiment, each cache 214a and 214b contains all trade data, while in other embodiments the trade data may be distributed or parceled among multiple caches in one or more servers.

The match modules 212a and 212b and/or caches 214a and 214b may communicate using the Java Messaging Service standard publish and subscribe application program interface (API). The type of information that may be exchanged includes information to add, update and remove trade and/or order data from caches 214a and 214b. Information may be communicated in a variety of formats, for example, information may be exchanged identifying changed information, providing a complete copy of the cached information, partial updates of segments based on time or activity or any other desired communication schedule or schema.

Servers 208a and 208b may further include aging queues 216a and 216b. Each aging queue or book may contain trade data representative of orders that have not been matched. Each book may contain a unique subset of unmatched trade data so that the workload is distributed across servers. In this way, different basis futures related to individual stock indexes may be handled by different books and aging queues deployed in one or more servers 208a, 208b to 208x.

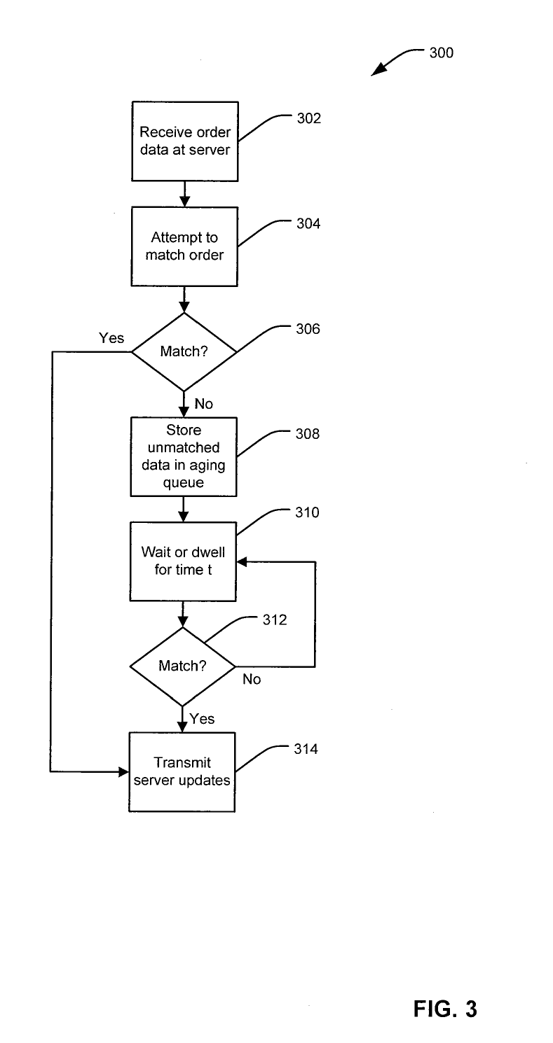

FIG. 3 illustrates an exemplary method 300 of matching orders in accordance with an embodiment disclosed herein. At block 302 of the method, order data is received at a match server identifying a particular class, price and quantity for a basis future. The method, as shown in block 304 may utilize one or more of the match modules 212 and the match client 206 in an attempt to match the received order data with other existing orders in the cache 214 and/or aging queue or book 216. The method bifurcates at block 306 based on whether or not the received order dated is matched by the match module 212 and/or the match client 206. If the match is made, the method skip ahead to block 314. Conversely, if the match is not made, the method continues to handle and process the received order data as discussed in blocks 308 to 312. In particular, the method at block 308 stores the unmatched order data in one or more of the aging queues or books 216. The order data, as shown in block 310, stored the unmatched order data for a predetermined period.

The method bifurcates again as shown at block 312 based on a determination of whether or not the order data stored within the aging queue or book 216 has been matched after the predetermined period of time shown in block 310. If the match is again not made, the method returned to block 310 to rest for a predetermined period. However, if the order data is matched, the method continues to the element or step discussed in connection with the block 314. After the order data is determined to be match at either block 306 and the block 312, the method discloses that the match data and match server state change information or other update information may be transmitted to the match servers 208.

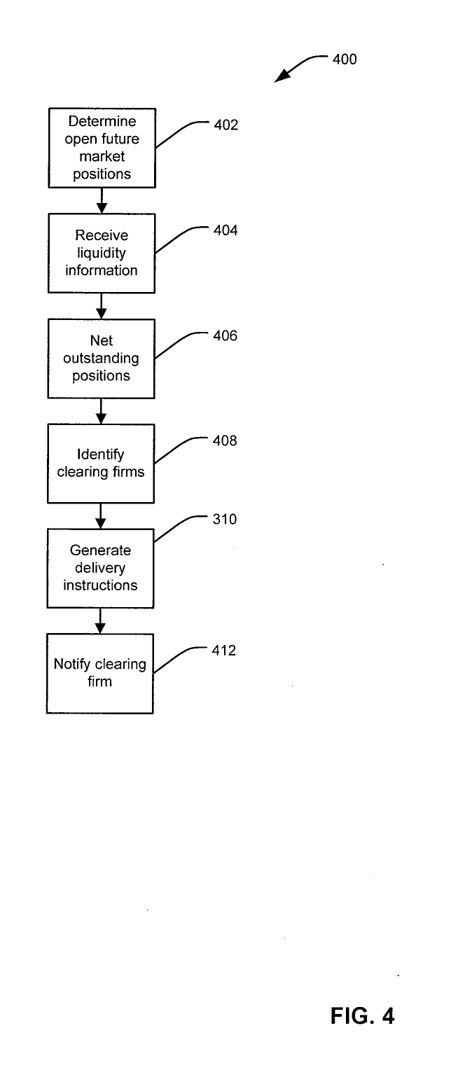

FIG. 4 illustrates an exemplary method 400 for clearing and settling open positions associated with basis futures. The exemplary method at block 402 determines and/or identifies each open position in a basis futures market prior to expiration of a basis futures contract of interest. The method at block 404 notifies a central counterparty of the liquidity of open basis futures contracts. The method as shown in block 406 provides for netting any outstanding long and short positions by the central counterparty. The netting may comprise mark-to-market of the outstanding long and short positions for clearing purposes. A clearing firm for each open position to be settled by delivery may be determined by the method as indicated at block 408. The clearing firm may be chosen from a list generated and maintained by the central counterparty clearing firm. Delivery instructions for each cleared and settled product may be generated by the method as shown in block 410. The method may further cause a notification including delivering instructions may to be communicated to the clearing firm as shown in block 412.

A detailed example of the method 400 may address basis futures that are settled through the delivery of one (1) nearby quarterly E-mini S&P 500 futures contract. In this example, a trader or first party may buy basis futures and be assigned one (1) long E-mini S&P 500 futures contract at 3:15 pm (CT); while a trader or second party may sell basis futures and be assigned one (1) short E-mini S&P 500 futures contract at 3:15 pm (CT). The assignments reflect a price equal to the closing value of the S&P 500 for the day, observed at 3:15 pm (CT), adjusted by the final settlement price of the basis futures contract.

In the manner discussed and disclosed above, the spot index value of the S&P 500 may be 1,120.00, while the basis futures contract associated with the S&P 500 of the present example settles at +3.50. The contract may be determined to have a value of 1,123.50 (=1,120.00+3.50). Alternately, if basis futures contract associated with the S&P 500 of the present example settle at −4.75, the contract be determined to have a value of 1,115.25 (=1,1,20.00−4.75). Each of the contracts references the 3:15 pm (CT) value of the spot S&P 500 index despite the fact that the U.S. equity markets normally close at 3:00 pm (CT) in order to allow markets to stabilize and the information related thereto to become available.

The basis future, unlike known TAS and TIC trading, provides a mechanism by which the futures contracts so that they can be purchased for future dates. In other words, basis futures can be extended to a forward listing so that forward basis can be traded. Instead of only being able to trade the basis for the given day that the basis futures contract is listed, as is the case with TAS and TIC trading, the current invention contemplates listing stock index futures in successively deferred months into the future. Moreover, the basis futures provide a mechanism by which a trader's perceptive of the fair value may be estimated with respect to the finance charge and the dividend.

In another embodiment, the basis may be quote for a basis future in terms of a interest rate as opposed to ticks. For example, the basis futures contract may be quoted on the interest rate basis, e.g., 1.50%, 1.51%. At the expiration at the end of the day, the underlying futures contract is delivered at determined by the following function:

Cash index Close Level×(1+basis×time to expiration)

In the preceding function, basis is the price of the basis futures contract. Quoting the basis in net interest rate terms has an advantage over quoting simply the basis: a large underlying index move late in the trading day can makes index point spreads meaningless.

Exemplary basis future contracts, as disclosed herein, provide investors a mechanism by which they may enter into a position based on both personal and quantitative perceptions of the fair value of the futures contract. Basis futures can be listed on a daily basis and are settled through the delivery of, for example, virtually an futures contracts such as an E-mini S&P 500 index futures contract. The basis futures contracts, in this exemplary embodiment, may be valued at the 3:15 pm Chicago Time, where the index futures position is determined to be the sum of (1) the spot value of the index plus the price of the basis futures. In this way, a trader or other investor may utilize basis futures to provide a mechanism to enter or exit positions in index futures at a value that reflects their perception of fair value on any particular day. This quoting mechanism may provide tremendous utility to arbitrageurs as well as institutional investors. For example, asset managers who practice “portable alpha” strategies are typically keen at ensuring that their transactions of the index futures are executed at levels as close to the fair value so that they may deliver a true “beta” return to their investors.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A method for implementing a basis futures contract, the method comprising:
receiving trade data at a server;
defining, at the server, a first futures contract based on an index identified in the received trade data;
defining, at the server, a second futures contract based on a basis associated with the index identified in the received trade data, wherein the basis reflects a fair value associated with the first futures contract;
listing, via a match module, at least the second futures contract;
matching, via the match module, at least the second futures contract; and
calculating, at the server, a final settlement price associated with the first contract based on a daily settlement price of the index and a basis future settlement price associated with the second contract.

2. The method of claim 1, where the second futures contract is a basis futures contract.

3. The method of claim 1, where the basis is a difference between an index future price and a spot index value.

4. The method of claim 1, wherein the fair value is a difference between a finance charge and a dividend.

5. The method of claim 1 further comprising:
storing the trade data associated with the first futures contract and the second futures contract in an aging queue.

6. The method of claim 1, wherein calculating the basis future settlement price occurs at a period after a daily close.

7. The method of claim 6, wherein the period after the daily close is at least fifteen (15) minutes after the daily close.

8. A computer implemented system for managing a basis future contract, the system comprising:
a server configured to receive trade data from a trading party, wherein the server is configured to:
generate a first futures contract based on an index identified in the received trade data;
define a second futures contract based on a basis associated with the index identified in the received trade data, wherein the basis reflects a fair value associated with the first futures contract;
a match module configured to list at least the second futures contract with a clearing counterparty, and wherein the match module if further configured to match at least the second futures contract; and
wherein the server is further configured to calculate a final settlement price associated with the first contract based on a daily settlement price of the index and a basis future settlement price associated with the second contract.

9. The system of claim 8, where the second futures contract is a basis futures contract.

10. The system of claim 8, where the basis is a difference between an index future price and a spot index value.

11. The system of claim 8, wherein the fair value is a difference between a finance charge and a dividend.

12. The system of claim 8, wherein the server is further configured to store the trade data associated with the first futures contract and the second futures contract in an aging queue.

13. The system of claim 8, wherein the server is further configured to calculate the basis future settlement price occurs at a period after a daily close.

14. The system of claim 13, wherein the period after the daily close is at least fifteen (15) minutes after the daily close.

15. A method of providing a basis future contract associated with a stock index futures contract, the method comprising:
identifying, via trade data provided to a match client, a stock index;
defining a basis future contact, wherein defining the contract comprises:
determining a basis associated with the basis index future contract as a difference between an index future price and a spot index value; and
determining a fair value associated with the basis index future contract as a difference between a finance charge and a dividend;
listing the basis future contract with a clearing counterparty; and
calculating, if the basis future contract is matched by a match module, a final settlement price associated with the stock index future based on a daily settlement price of the index and a basis future settlement price associated with the basis future contract.

16. The method of claim 15 further comprising storing trade data associated with the stock index future contract and the basis futures contract in an aging queue.

17. The system of claim 15 wherein the basis future settlement price occurs at a period after a daily close.

18. The system of claim 17, wherein the period after the daily close is at least fifteen (15) minutes after the daily close.
